(19) United States
(12) Patent Application Publication
(10) Pub. No.: US 2010/0241983 A1
(43) Pub. Date: Sep. 23, 2010

(54) System And Method For Accelerometer Based Information Handling System Keyboard Selection

(76) Inventors: Erin K. Walline, Pflugerville, TX (US); Justin Lyles, San Diego, CA (US)

Correspondence Address: HAMILTON & TERRILE, LLP, P.O. BOX 203518, AUSTIN, TX, 78720, US

(21) Appl. No.: 12/405,355

(22) Filed: Mar. 17, 2009

(51) Int. Cl. G06F 3/048; G06F 3/041; G01P 15/00

(52) U.S. Cl. 715/773; 345/173; 702/141

(57) ABSTRACT

An information handling system presents a keyboard at a touch screen display to accept end user key inputs. An accelerometer integrated in the information handling system detects accelerations that indicate a change in the configuration of the keyboard presented at the touch screen display. The keyboard presentation adjusts from a full size that accepts end user inputs to a reduced size that provides the end user with increased display area for alternative uses. For example, an acceleration commands keyboard minimization, keyboard presentation at a reduced size, partial keyboard presentation, keyboard presentation to avoid key fields that accept use inputs, keyboard presentation with a configuration having fewer keys, or other types keyboard configurations.

### BACKGROUND OF THE INVENTION

1. Field of the Invention

The present invention relates in general to the field of information handling system input/output devices, and more particularly to a system and method for accelerometer based information handling system keyboard selection.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The availability of inexpensive yet powerful processing components has resulted in the development of a variety of miniaturized processing devices, such as mobile Internet devices (MIDs). Such devices tend to provide functionality that falls between that offered by cellular telephones and conventional portable information handling systems, such as laptop devices having a housing with a clamshell configuration. For example, a typical mobile Internet Device has a five inch touch screen display that presents visual information much as does a portable information handling system and also acts as the primary input device. The touch screen display presents visual icons that an end user can select or a visual keyboard that accepts end user typed inputs. Adequate processing power and storage are available for the device to perform most basic functions available with an information handling system, such as Internet browsing and e-mail functions performed through a wireless network access, such as an 802.11(g) network interface. Yet, the housing of the device has a small size that provides convenience for end users who travel or otherwise need processing resources on the go.

As a bridge device sized between a portable information handling system and a cell phone, mobile Internet devices often include elements borrowed from both portable information handling systems and cell phones. One example of an element borrowed from cell phones is the integration of an accelerometer that accepts end user gestures to command functions at the mobile Internet device. For instance, an accelerometer integrated in the housing of a mobile Internet device could initiate a scroll of a browser if the housing is tilted. Tilting the housing so that the top dips scrolls the browser in one direction while tilting the housing so that the top rises scrolls the browser in the opposite direction. As another example, shaking the housing could initiate a thumbnail presentation of files stored on the system. The use of an integrated accelerometer in a mobile Internet device allows for a variety of inputs that would have difficulty in full-sized portable information handling systems that have a clam shell configuration with a rotationally-coupled lid.

### SUMMARY OF THE INVENTION

Therefore a need has arisen for a system and method which controls an information handling system I/O device using accelerometer inputs.

In accordance with the present invention, a system and method are provided which substantially reduce the disadvantages and problems associated with previous methods and systems for controlling an information handling system I/O device with accelerometer inputs. An accelerometer detects an acceleration input at an information handling system housing to initiate selection of an alternative keyboard configuration presentation at a touch screen display. The keyboard alternates between one or more configurations selectable by an end user to provide desired access to content otherwise displayed on the touch screen display beneath the keyboard.

More specifically, an information handling system has plural processing components disposed in a housing having an integrated touch screen display. An accelerometer disposed in the housing detects predetermined accelerations that indicate a keyboard selection. A keyboard manager running on a processing component, such as firmware stored in flash memory and executed on a processor of a chipset, selectively configures the keyboard based upon detected acceleration inputs, such as tilting the information handling system housing along a predetermined axis. The configurations vary the size and location of the keyboard presented, including removal of the keyboard all together, minimizing the keyboard, moving the keyboard to present a field otherwise under the keyboard, sliding the keyboard in the direction of an acceleration, reducing the size of the keyboard or reducing the number of keys presented in the keyboard.

The present invention provides a number of important technical advantages. One example of an important technical advantage is that an end user inputs a keyboard presentation configuration selection without having to touch the touch screen display. For example, if an end user desires to input values in a field presented on a touch screen display beneath the keyboard, the end user tilts the housing to provide an acceleration input that initiates a desired placement of the keyboard relative to the field. In the new placement selected by the acceleration input, the end user has access to input information in the field with the field in view instead of beneath the keyboard. As another example, if an end user wants to have a display of content without interference by the keyboard, an acceleration input removes the keyboard from all or substantially all of the display area having content to provide the end user with a substantially unhindered view of the content. A subsequent acceleration input returns the keyboard to view for use in accepting inputs. The availability of acceleration inputs relieves the end user from extra inputs at the touch screen display to select a keyboard configuration.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system having a keyboard presented at a touch screen display to accept end user letter and number key inputs;

FIG. 2 depicts a block diagram of an information handling system that selectively configures a touch screen display keyboard based upon inputs sensed by one or more accelerometers;

FIG. 3 depicts an information handling system keyboard presented at a touch screen display slid substantially out of view with an acceleration input detected by an accelerometer;

FIG. 4 depicts an information handling system keyboard minimized at a touch screen display with an acceleration input detected by an accelerometer;

FIG. 5 depicts an information handling system content field revealed from beneath a keyboard with an acceleration input detected by an accelerometer;

FIG. 6 depicts an information handling system keyboard selectively configured with a reduced but still usable size by an acceleration input; and

FIG. 7 depicts an information handling system keyboard selectively configured with and without a number keypad by an acceleration input.

### DETAILED DESCRIPTION

Acceleration inputs made at an information handling system provide a convenient selection of keyboard configuration for a keyboard presented at a touch screen display. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

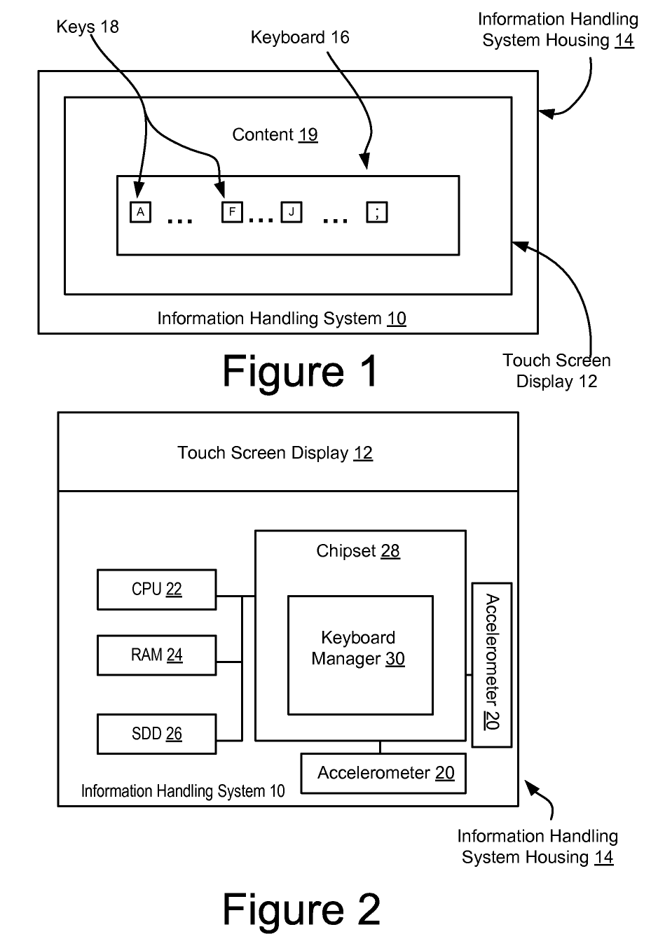

Referring now to FIG. 1, an information handling system 10 is depicted with a touch screen display 12 integrated in a housing 14. Touch screen display 12 presents a keyboard 16 that accepts end user letter and number inputs at keys 18, much as does a conventional physical keyboard having physical letter keys, number keys, function keys and other conventional keys. Content 19 presented at touch screen display 12 is presented beneath keyboard 16 so that an end user can make inputs with keyboard 16. In one embodiment, keyboard 16 has a translucent appearance so that content 19 beneath keyboard 16 is at least partially visible. As an example, content 19 is a Web browser that presents Internet content based on inputs made by an end user at keyboard 16. In alternative embodiments, content 19 is presented by alternative applications including e-mail and word processor applications controlled by inputs made through keyboard 16.

Referring now to FIG. 2, a block diagram depicts an information handling system 10 that selectively configures a touch screen display 12 keyboard 16 based upon inputs sensed by one or more accelerometers 20. Information handling system 10 is built with a plurality of processing components that cooperate to process information, such as a CPU 22, RAM 24, a solid state drive 26 and a chipset 28. In the example embodiment depicted by FIG. 2, chipset 28 includes processing components and memory that interface with accelerometers 20. Accelerometers 20 detect accelerations in predetermined axes that indicate an input by an end user. A keyboard manager executing on a processor within chipset 28 detects predetermined accelerations sensed by accelerometers 20 and selectively adjusts the presentation of keyboard 16 in response to the detected accelerations. Keyboard manager 30 is, for example, firmware instructions stored on a computer readable medium within chipset 28. In alternative embodiments, keyboard manager 30 may run on alternative processors, such as CPU 22, and may be stored in alternative computer readable mediums, such as RAM 24 or solid state drive 26. Accelerometers 20 may detect accelerations made along one or more axes, such as by including an accelerometer on each of plural perpendicular axes. The selection of predetermined keyboard configurations in response to predetermined accelerations is stored in keyboard manager 30 and may include plural keyboard configurations with each keyboard configuration selected by an acceleration along an associated axis. An end user may adjust keyboard configuration selections by changing the settings stored in keyboard manager 30.

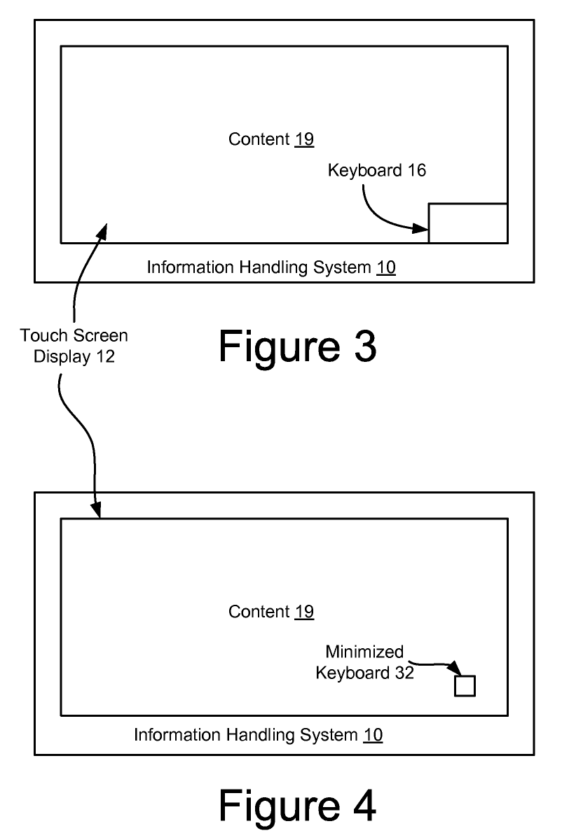

Referring now to FIGS. 3 through 7, various selections of keyboard configurations by acceleration inputs are depicted. In the example embodiment depicted by FIG. 3, content 19 is exposed from beneath keyboard 16 by sliding keyboard 16 from a position over content 19 to a position off to a side of keyboard 16. For example, a tilt of housing 14 to the right is detected by an accelerometer 20 causing keyboard manager 30 to slide keyboard 16 as if sliding down an incline in the direction of the tilt. In the depiction presented by FIG. 3, substantially all of keyboard 16 is slid off the side of touch screen display 12 to expose content 19 while a small portion of keyboard 16 remains visible to remind the end user where keyboard 16 has gone. To return keyboard 16 to a usable position over content 19, a tilt in an opposing direction, i.e., to the left, causes keyboard manager 30 to slide keyboard 16 back over content 19. Keyboard 16 may be slid to any side of housing 14 with the direction of the slide corresponding to the tilt-created incline detected by accelerometers 20. The end user may lock keyboard 16 or adjust the slide responsiveness to tilting as needed during use through an interface with keyboard manager 30. As an alternative to a sliding motion, FIG. 4 depicts a minimized keyboard indicator 32 that is presented instead of a keyboard upon detection of an acceleration along a predetermined axis. The keyboard is returned and the minimized keyboard indicator removed if a subsequent acceleration is detected.

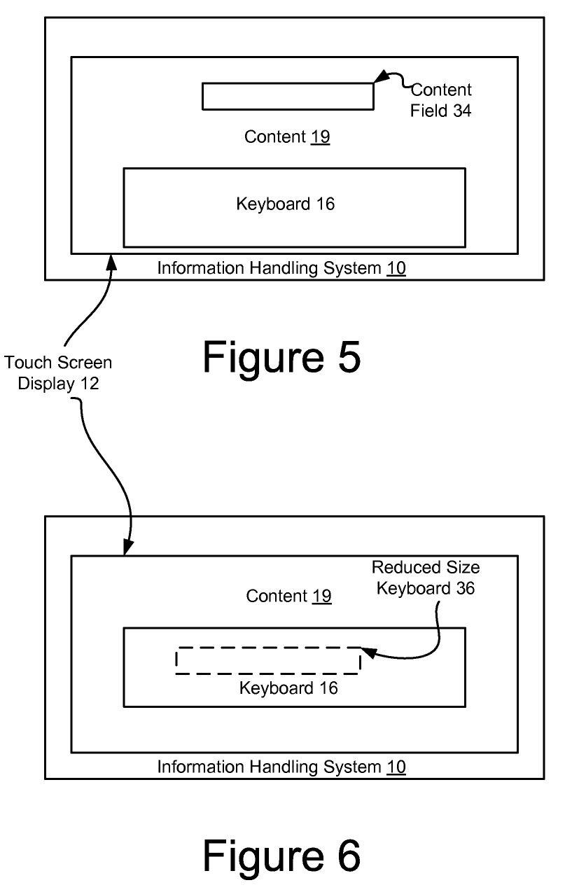

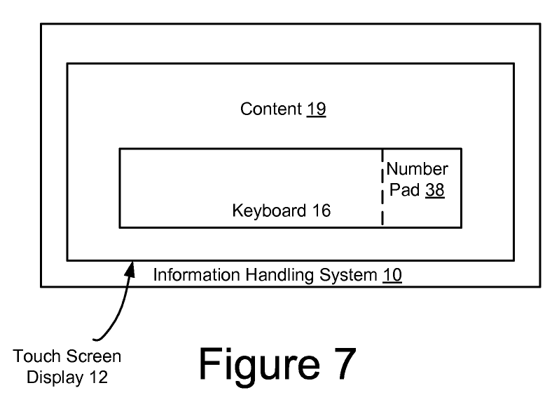

FIG. 5 depicts an example embodiment in which the keyboard 16 presentation depends upon the type of content 19 at detection of an acceleration. An end user who needs to input information to a content field 34 that is located under keyboard 16 brings content field 34 into view by an acceleration input, such as a tilt of housing 14 to a side. Upon detection of the acceleration and the presence of a field 34 in content 19 that is underneath keyboard 16, keyboard manager 30 automatically moves keyboard 16 so that field 34 is revealed. In one embodiment, keyboard 16 is moved to reveal field 34 so that keyboard 16 remains available for use to input information in field 34. In another embodiment, content 19 is adjusted so that field 34 falls in a location that allows full access to keyboard 16. FIG. 16 depicts another alternative embodiment in which an acceleration input results in presentation of keyboard 16 in a reduced size that has a smaller footprint across touch screen display 12. The reduced foot print of the smaller keyboard 36 provides a greater area for viewing of content 19 while still leaving a keyboard 36 of adequate size to readily accept end user inputs. A subsequent acceleration input selects return to the full-sized keyboard 16. FIG. 7 illustrates an alternative manner of reducing the size of keyboard 16 by removing at least some of the keys 18 presented at keyboard 16. In the embodiment depicted by FIG. 7, a number pad 38 is alternatively presented or removed with each acceleration input. In alternative embodiments user-selectable key configurations are presented, such as by selective removal and representation of function keys, number keys or other keys with each acceleration input. In various embodiments, various combinations of the selectable keyboard presentations of FIGS. 3 through 7 are presented as selected by an end user and stored in keyboard manager 30.

In alternative embodiments, an accelerometer used to detect accelerations associated with movement of an information handlings system may be replaced with other types of motion detectors or even a manual switch located at the housing of the information handling system. In addition to control of a keyboard, an acceleration might control presentation of other I/O devices or application windows. For example, an end user programs the information handling system so that a predetermined acceleration input selects presentation of a calculator user interface and removal of the calculator user interface. In one embodiment each acceleration selects removal of the primary window presented at the display and presents the next window under the primary window as the primary window. Thus an end user programs the keyboard module to sequentially present each window created at the display in a continuing loop so that an end user can sequentially view information in each window.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor disposed in the housing and operable to process information;
a touch screen display disposed in the housing and interfaced with the processor, the touch screen display operable to present a keyboard and to accept key inputs at the presented keyboard;
an accelerometer disposed in the housing and interfaced with the processor, the accelerometer operable to detect an acceleration along a predetermined axis; and
a keyboard manager executing on the processor and operable to selectively adjust presentation of the keyboard upon detection of an acceleration along the predetermined axis.

2. The information handling system of claim 1 wherein the keyboard manager selectively adjusts presentation of the keyboard by removing the keyboard from the display to present visual information otherwise presented under the keyboard.

3. The information handling system of claim 1 wherein the keyboard manager selectively adjusts presentation of the keyboard by detecting visual information that has a field to accept typed inputs, the field presented beneath the keyboard, and by moving the field on the display relative to the keyboard so that the field is visible at the display.

4. The information handling system of claim 1 wherein the keyboard manager selectively adjusts presentation of the keyboard by sliding the keyboard to a position that is substantially not visible at the display.

5. The information handling system of claim 4 wherein the keyboard slides in a direction corresponding to the axis of the acceleration.

6. The information handling system of claim 4 wherein the keyboard manager is further operable to slide the keyboard to a visible position in response to an acceleration on an opposing axis of the predetermined axis.

7. The information handling system of claim 1 wherein the keyboard manager comprises firmware instructions executing on the processor.

8. The information handling system of claim 1 wherein the keyboard manager selectively adjusts presentation of the keyboard by reducing the size of the keyboard presented on the display.

9. The information handling system of claim 1 wherein the keyboard manager selectively adjusts presentation of the keyboard by adjusting from a presented configuration to a reduced footprint configuration.

10. A method for selecting presentation of a keyboard at a touch screen display, the method comprising:
presenting the keyboard in a first configuration;
detecting an acceleration at the touch screen display; and
in response to the detecting, presenting the keyboard in a second configuration.

11. The method of claim 10 wherein the first configuration comprises a full keyboard presentation operable to accept key inputs and the second configuration comprises a minimized presentation not operable to accept key inputs.

12. The method of claim 10 further comprising:
detecting a field for keyed inputs presented beneath the keyboard presented in the first configuration;
wherein the second configuration comprises moving the keyboard relative to the field to expose the field for presentation at the display.

13. The method of claim 10 wherein in response to the detecting, presenting the keyboard in a second configuration further comprises sliding the keyboard substantially out of view in a direction corresponding to the acceleration.

14. The method of claim 10 further comprising:
detecting a second acceleration opposite the first acceleration; and
in response to the detecting a second acceleration, returning the keyboard to the first configuration.

15. The method of claim 10 wherein the first configuration comprises more keys than the second configuration.

16. The method of claim 15 wherein the first configuration comprises letter keys and a number pad and the second configuration lacks the number pad.

17. A system for managing presentation of a keyboard at a touch screen display, the system comprising:
an accelerometer operable to detect one or more predetermined accelerations; and
a keyboard manager interfaced with the accelerometer and operable to adjust presentation of the keyboard between first and second configurations in response to the one or more predetermined accelerations.

18. The system of claim 17 wherein the first configuration comprises a visible configuration of a first size presented to accept key inputs and the second configuration comprises a reduced size configuration having a smaller size than the first size.

19. The system of claim 18 wherein the reduced size configuration comprises a minimized configuration.

20. The system of claim 18 wherein the reduced size configuration has a second size presented to accept key inputs.
